(19) United States
(12) Patent Application Publication
(10) Pub. No.: US 2008/0270836 A1
(43) Pub. Date: Oct. 30, 2008

(54) STATE DISCOVERY AUTOMATON FOR DYNAMIC WEB APPLICATIONS

(76) Inventors: Praveen KALLAKURI, Mountainview, CA (US); Keerat Sharma, Pacific Junction, IA (US); Vishal Santoshi, Brooklyn, NY (US)

Correspondence Address: HUSCH BLACKWELL SANDERS LLP, 1620 DODGE STREET, SUITE 2100, OMAHA, NE, 68102, US

(21) Appl. No.: 11/960,379

(22) Filed: Dec. 19, 2007

Related U.S. Application Data
(60) Provisional application No. 60/870,844, filed on Dec. 19, 2006.

(51) Int. Cl. G06F 11/27

(52) U.S. Cl. 714/37; 714/E11.169

(57) ABSTRACT

An automaton that detects possible states and transitions that can possibly exist in a web based application is provided. The automaton may comprise a plugin system, an HTTP processor, an application handler, a page handler, an input handler, journals, a coverage analyzer, an expression language interpreter, and a data validator.

### CROSS REFERENCE TO RELATED APPLICATIONS

The present Application claims the benefit of and priority as available under 35 U.S.C. § 119 to U.S. Provisional Patent Application 60/870,844, filed Dec. 19, 2006, which is incorporated by reference in its entirety.

### BACKGROUND OF THE INVENTION

Testing dynamic web applications in a reliable, repeatable, efficient, measurable, and effective manner is a challenge that most test engineers face. Such testing is a challenge and unsolved problem. The present invention solves at least this problem.

For web applications that are considered to be dynamic, deterministic, and finite state machines, the present application provides an automaton that detects all possible states and transitions that can possibly exist. Normally test engineers manually write tests to traverse the application under test (AUT). Whenever any part of the AUT changes, test engineers have to invariably update or enhance their test suite to ensure that the new and changed parts of the AUT are covered. The automaton of the present invention is immune to such changes because it dynamically discovers subsequent states in a state machine using the information collected by traversing previous states. In addition, the automaton can be plugged in with various types of validators that can query an underlying persistence so that data entered on a website can be verified at its destination. Additionally, the discovery mechanism can be altered depending on the need using various types of coverage algorithms (random, additional coverage, etc.).

### SUMMARY OF THE INVENTION

In an embodiment of the present invention, the automaton comprises:
(1) A module the decomposes web pages into an object representation of HTML form elements;
(2) A set of handlers, each of which is responsible for manipulating a specific HTML form element;
(3) Journals that remember all pages and inputs seen during the current and historical runs;
(4) A core engine that is or can be piggy-backed with a coverage algorithm to dynamically compute values for HTML form inputs;
(5) A module that divides the value-space of each input into equivalence classes and in doing so is able to recommend input-values; and
(6) A module that can quantify the coverage achieved.+

### DESCRIPTION OF SEVERAL VIEWS OF THE DRAWINGS

FIG. 1 illustrates an overall method and process flow of an embodiment of the present invention.

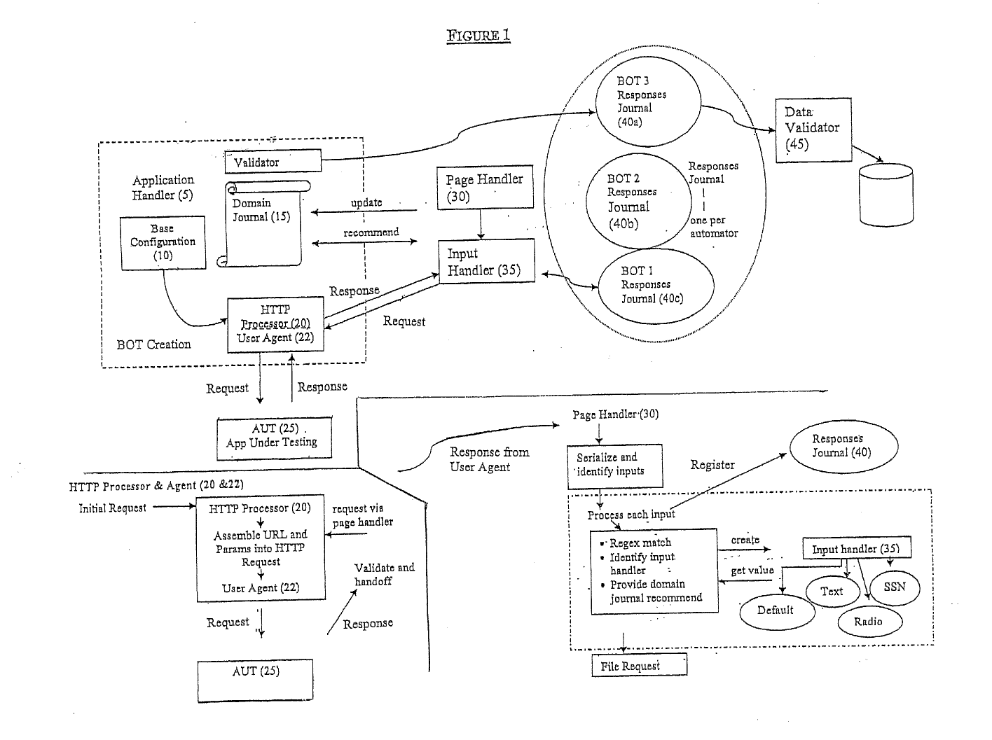

### DETAILED DESCRIPTION OF THE INVENTION

Core Artifacts. In an embodiment of the present invention, the core infrastructure of the automaton comprises the following artifacts:
1. A plugin system
2. An HTTP Processor 20 for user-agent emulation
3. An application handler 5 and its derivatives (plugins)
4. A page handler 30 and its derivatives (plugins)
5. A input handler 35 and its derivatives (plugins)
6. Journals to keep track of pages and inputs seen so far
7. A coverage analyzer that quantifies coverage of the Application Under Test (AUT) 25 based on various adequacy criteria
8. An expression language interpreter for controlling input processing
9. A data validator 45 and its derivatives (plugins)

Each of the above artifacts are discussed in detail in the following sections.

1. Plugin system. An object representation of the Application Under Test (AUT) 25 includes the following hierarchy: (a) Application (b) Page (c) Input. The content-handlers built into the automaton reflect an identical hierarchy: (a) Application handler 5 abstraction (b) Page handler 30 abstraction (c) Input handler 35 abstraction. An embodiment of the automaton includes concrete implementations of each of these abstract handlers. However, an alternative embodiment overrides the default behavior. Therefore the automaton is equipped with a plugin system. Most artifacts and their concrete implementations are in fact plugins.

2. The application handler abstraction. In an embodiment of the concrete implementation of this abstraction a caller instantiates the application handler 5 abstraction with a number of initialization parameters that are mostly passed on to artifacts invoked by the application handler 5. These initialization parameters comprise:
Base URI from which the automaton should start execution
Optional path and query parameters
Adequacy criterion
Flag to indicate whether reverse-navigation is to be simulated
Flag to indicate whether execution should abort midway and restart, to simulate a user interruption

The application handler 5 then instantiates a journal unique to the AUT 25 and sets up the runtime environment.

The application handler 5 serves as a broad container for configuration and data pertaining to a given bot. It contains the base configuration 10 that provides the HTTP Processor 20 and User Agent 22 with all the information they need to communicate with the AUT 25. In addition, it contains the domain journal 15 which is the registry for all the inputs encountered and the values that have been exhausted. It also contains the response journals 40 from completed bots that can be handed to data validators 45 or other engines. The bot execution configuration held within the application handler 5 has directives that the page handler 30 can delegate to the input handlers 35 to help in the creation and/or management of value creation. Lastly, the application handler 5 can also serve as a receptacle for test cases. These test cases are complete scenarios filled out where specific known inputs have predefined values that a given bot will trace through the application.

Finally, a HTTP Processor 20 is instantiated for communication with the AUT 25.

3. User-agent emulation. In an embodiment of the present invention, all communication with the AUT 25 occurs through a HTTP Processor 20. An instance of the HTTP Processor 20 is created every time the automaton is executed.

Upon instantiation, a HTTP Processor 20 in turn creates a User Agent 22 that simulates a basic web browser. A controlled cycle of sending an initial HTTP Request to the AUT 25, receiving a response, manipulating it by manufacturing inputs and submitting a new HTTP Request—all using the User Agent 22—simulates a human interacting with a web application.

At its inception, the HTTP processor 20 uses the user agent 22 to initialize an interaction with the AUT 25 by creating a HTTP Request using the base URL Once the AUT 25 responds with a HTTP Response, the user agent 22 determines its validity and takes one of the below routes:

1. If the HTTP Response is valid, then the user agent 22 hands over the response to the HTTP processor 20 for further action.

2. If the HTTP Response contains a HTTP redirect code, then the processor follows the redirect URI and examines the result of that request.

3. If the HTTP Response contains an HTTP error code, then the user agent 22 aborts execution and propagates the error to the HTTP processor 20.

If the HTTP Response is found to be satisfactory, then the HTTP processor 20 deserializes the HTTP Response into an object hierarchy of HTML elements. This enables various input handlers 35 to manipulate the corresponding HTML element effectively. These input handlers 35 are described further in a separate section infra.

Once various handlers have processed the HTTP Response, the application handler 5 hands over the modified response to the HTTP processor 20. The processor 20 then serializes the modified response into a HTTP Request and invokes the user agent 22 for transmitting it back to the AUT 25.

The HTTP Processor 20 also has the task of differentiating a response from the AUT 25 from the previous response. Often, when the user submits an input on a page, the logic of the AUT 25 may result in some assertion or validation failing, and the resultant response is nothing but the previous response with an error message. In such scenarios, it is the responsibility of the HTTP Processor 20 to handle the erroneous HTTP Request appropriately, as determined by a runtime parameter. In order to facilitate the identification of such cases, the HTTP Processor 20 manufactures a signature that identifies each HTTP Response uniquely. The mechanism to create the signature is configurable. For example, in an embodiment of the present invention, the mechanism to create the signature is based on the input names within the content of the HTTP Response or some form of encoding of the response content. Whatever be the mechanism, the implementation within the present invention is mindful of content that always changes, for instance, the system time of a dynamically generated response by the AUT 25.

Reverse Navigation. In a true user environment, when a web application responds to a user request, the user could backup one or more pages and submit a historical page instead of submitting the latest page. There are two possibilities when this happens:

1. The historical request is sent to the AUT 25 without any further modifications, in which case, the new request is an exact replica of the historical request.

2. The historical request is manipulated (its inputs are modified so that they are no longer the same) so that the new request is unique within the context of the current interaction.

So that this scenario is simulated effectively, the HTTP processor 20 is equipped with a cache that stores every HTTP Request ever generated. Either at a randomly determined or a specified page, the HTTP processor 20 decides to send the historical request, either modified or as is, instead of sending the latest manipulated response. When this happens, the entries in the journal corresponding to the intermediate HTTP Requests can optionally be rolled back, depending again on a runtime parameter.

4. The page handler abstraction. Each HTTP Response, upon being deserialized into an object representation is handed to the page handler 30 by the application handler 5. The task of the page handler 30 is to verify that the response from the AUT 25 has inputs that can be manipulated. Once this has been asserted, the page handler 30 creates a unique signature for the page using one of several possible algorithms (hash-based, input-name-based, et al) and proceeds to register each input on the page with the journal. The page signature is used by both the domain and response journals.

Page Handlers 30 can be extended to implement specific logic that might be proprietary to a type of page like a login screen or a demographics space. These provide for the page handler 30 to introspect the available inputs on the page and to provision for custom values for them.

The page handlers 30 process each input in a number of ways. First, they check to see if the input names match some supplied criteria (regular expression or a supplied parameter list or uploaded scenario files) and react accordingly. If input doesn't meet any criteria that has been configured in the application handler 5, the page handler 30 then delegates the responsibility of creating a value to be submitted for the input to a specific input handler 35. Input handlers 35 are chosen by examining how a web browser would treat a given input. These can vary between text boxes, radio buttons, drop down selects and the like. The page handler 30 leverages the domain journal 15 by asking it to supply a recommendation for what the input handler 35 should try to utilize as a value. This mechanism is discussed further in Section 7. Input handlers 35, like page handlers 30, can be customized or sent in additional parameters to come up with values in a specific fashion. Examples of input handlers 35 include creating values for email addresses and phone numbers. The input handlers 35 can be equipped with logic that leverages the name to attempt to generate a value that makes sense. For example, if the name is a Social Security Number (SSN) and the field is a text input, then there's a strong likelihood that the generated input will need to generate a value that conforms to the specification of a social security number. Likewise for a field named or containing the word “email”, there is a strong likelihood that the desired response would be one that conforms to the pattern laid out by an email address.

Equipped with a set of values for all the inputs on the page, the page handler 30 proceeds to hunt within the page to find a mechanism to submit responses, typically a button that will allow for the submission of the data entered. If no clear button is found, the handler searches for a link, any link that will allow it to move through the AUT 25.

Once a determination is made on how to proceed by the rules above, the page handler 30 submits a request to the AUT 25 via the User Agent 22 that is compiled from all the values that it gathered via the input handlers 35. If the request is successful, then the page handler 30 proceeds to register the supplied arguments to both the domain 15 and responses 40 journal. This allows for tracking of variable submission at both the global application level, and the individual automaton level.

5. The input handler abstraction.

State space analysis of input domain. HTML content, whether statically or dynamically generated, contains basic user-input elements that are universal. For example, a typical HTML response consists of a number of hyperlinks and, optionally, one or more forms that in turn contain textfields, radio-buttons, select-lists, buttons and images, et al. Contemporary web applications also make extensive use of form elements driven by JavaScript- and AJAX-like technologies that facilitate client-side processing of user requests and/or minimal requests to the web-application server that responds with a partial reload of content visible to the user.

Irrespective of whether the content is static or dynamic, and whether or not the inputs are managed by client-side or server-side processing logic, every user-input can be characterized as consisting of a value-domain of discrete values that the input can accept during a particular interaction. For instance, consider an input X with a state X_{Sm} encountered during a traversal Tₘ of the automaton through a web application. The domain of X in this state is:

D_{Sm}^{X}={Φ,x,y,z}

It is possible that during a different traversal Tₙ, the input has a state X_{Sn} and has domain:

D_{Sn}^{X}={Φ,x,y,z}

The automaton must therefore, remain cognizant of all historical states and corresponding domains of every input to ensure that all values are exercised and in their respective contexts. Formally,

y(n)=Cₓ₍ₙ₎+Dᵤ₍ₙ₎

x(n+1)=Aₓ₍ₙ₎+Bᵤ₍ₙ₎

where x(n) is a state vector of length N at discrete time n, u(n) is a p×1 vector of inputs, and y(n) is the q×1 vector of outputs. A is an N×N state transition matrix. (Julius O. Smith III. Introduction to digital filters with audio applications. http://ccrma.stanford.edu/jos/filters/filters.html, September 2005.)

Domain exploration of inputs with finite value-sets is an intrinsic characteristic of the automaton. However, not all inputs have a finite domain. Consider a textfield or a textarea where the user can key in arbitrary text of any length. Most applications impose a length constraint on such unbounded inputs; but even if we consider finite length values within the value-domain, an automaton that is tasked with sampling an unbounded domain could easily attain exponential complexity. In such scenarios where the length of the input-values may or may not be constrained and the domain itself is unbounded, the automaton resorts to one of two options:
If the input values are constrained in some manner by runtime parameters, then the automaton samples the smaller domain for possible values to assign to the input. For example, a setup parameter that indicates that unbounded inputs with the name containing the literal “year” need to be assigned a randomly generated year between 1900 and 2050, instead of sampling the entire ASCIII character set for possible values significantly reduces the expense of sampling the entire ASCII character set for possible values. This is described further in Section 6 infra.
If there are no length or character-set constraints on the value-domain of the input, then the automaton partitions the domain before sampling the individual partitions. Partitioning input domains into equivalence classes is a well known technique for handling extremely large or unbounded domains. Equivalence classes in the ASCII character set may for instance be the set of numbers, alphabet, special characters, and combinations of two or all three sets.

Bounded and unbounded input handlers. Concrete implementation of the aforementioned domain exploration technique is manifested in an abstract Handler interface and two derivatives:

1. Bounded input handler: Inputs that have a finite set of pre-determined values in their value domain are handled by this class of handlers. Examples as mentioned before, are radio-button handlers, checkbox handlers, option-input handlers, et al.

2. Unbounded input handler: On the other hand, inputs that allow the user to enter any length of strings containing for instance, the 95 printable ASCII character set, or any other set of characters belonging to any other encoding are handled by the automaton using unbounded input handlers.

In an embodiment of the present invention, the default input handling mechanism is overridden. This embodiment implements a new handler that conforms to the Handler interface and the Bounded Input Handler interface (for bounded inputs) or Unbounded Input Handler interface (for unbounded inputs). This embodiment then registers the new handler with the plugin system. This extensibility can be leveraged for handling even non-trivial elements that probably are controlled by JavaScript, AJAX, Flash or any other artifacts that could possibly be embedded in HTML content. By abstracting the input type from its domain and making the handlers pluggable the automaton can be equipped to handle virtually any kind of content.

Bounded input handlers. This handler is an abstraction over the class of bounded inputs. The value for a bounded input is chosen from a domain that could potentially increase in size, but always remains bounded.

Note that the set of values in a bounded domain also includes the null value—the state where no value is chosen at all. Apart from the input not being assigned a value, there is really no other invalid state possible for bounded inputs.

Unbounded input handlers. HTML form elements such as the textfield, textarea, file-upload field, etc all allow a web application to accept input-values that may be of any length and encoding. Unbounded input handlers are derivatives of this abstraction that specifically implements domain-exploration through partitioning possibly infinite domains into equivalence classes.

6. Restricted inputs. Section 5 discussed a feature where inputs with possibly infinite-sized domains are “regulated” using runtime parameters. This section describes the feature in detail.

Often, a test engineer may seek to limit the number of choices the automaton can make when selecting a value from the domain of an input. Quoting a previously used example, it may be desired that the automaton use a number between 1900 and 2050 whenever it encounters an input whose name matches the literal year.

The current infrastructure suffices this requirement through the use of input constraints. Input constraints are limitations imposed on the automaton when examining the domain of an input for selection of an assignable value. Common constraints could be:

If name≈year then value=_RANGE{1900-2050}

If name≈consent then value={1,2}

If name≈(literal1\literal2\literal3) then value=_NATURALNUMBER.

Names in input constraints can be either literals or regular expressions and values can themselves be literals, comma-separated values (where one of the values is chosen randomly each time the input is encountered). This expression language is highly extensible and used to control inputs even if they have unbounded domains.

7. Journal. The journaling system exists on two related but separate spaces. The first is the domain journal 15. The domain journal 15 tracks the total set of pages that have been discovered within an application, and the values that all the bots have encountered on each page. This is the mechanism by which the present invention computes the total coverage of the application. It is also the mechanism by which the present invention centralizes all paths that the disparate bots have taken through the application so that the domain journal 15 can suggest new paths based on inputs for which the automaton of the present invention has not yet exhausted values. The domain journal 15 is constantly interrogated by the page handler 30 for suggestions on values as the page handler 30 delegates value generation to the input handlers 35.

The second related but separate space of the journaling system is the response journal 40. The response journal 40 is a limited journal that traces the path of a single bot, reflecting the course that a given user might chart through the application. Each domain journal 15 consists of many tiny wedges that represent unique combinations of inputs and path traversals through the AUT 25. The total set of response journals 40a-c is represented by the domain journal 15. The response journal 40 is important in that the page handler 30 and application handler 5 can leverage the state of a user to simulate concepts like reverse navigation and jumping ahead only by knowing where a specific bot is at present and how they managed to get there.

8. Coverage analysis. The AUT 25 as a linear system. It is common for web applications to contain multiple inputs on a single page. Therefore, given inputs i₁ through i_{z}, traversal t, domain D and the set of values in that domain S,

Dᵢ_{₁}^{t}^{₁}=Sᵢ_{₁}¹, Dᵢ_{₁}^{t}^{₂}=Sᵢ_{₁}², . . . Dᵢ_{₁}^{t}^{ₘ}=Sᵢ_{₁}^{m}

Dᵢ_{₂}^{t}^{₁}=Sᵢ_{₂}¹, Dᵢ_{₂}^{t}^{₂}=Sᵢ_{₂}², . . . Dᵢ_{₂}^{t}^{ₙ}=Sᵢ_{₂}ⁿ

. . .

. . .

Dᵢ_{_{z}}^{t}^{₁}=Sᵢ_{_{z}}¹, Dᵢ_{_{z}}^{t}^{₂}=Sᵢ_{_{z}}², . . . Dᵢ_{_{z}}^{t}^{_{w}}=Sᵢ_{_{z}}^{o}

Assuming that the AUT 25 is a deterministic, linear system, the number of traversals required to cover all possible states of every input on a page is equal to the sum of traversals required to cover all the states of every input on a page. Formally, given n valid complex inputs, x₁(t) through xₙ(t), as well as their respective outputs,

y₁(t)=H(x₁(t))

y₂(t)=H(x₂(t))

. . .

. . .

yₙ(t)=H(xₙ(t))

where H is an operator that maps an input x(t) as a function of t to an output y(t), then the AUT 25 must satisfy,

αy₁(t)+βy₂(t)+ . . . +εyₙ(t)=H(αx₁(t)=βx₂(t)+ . . . +εxₙ(t))

for any set of scalar values α, β, . . . ε.

Based on this linear system formulation, the automaton predicts the number of traversals that remain to be executed at any given point of time during its exploration of the AUT 25.

4.9 Data validation. A secondary purpose to the response journal 40 is to contain a payload that shows a specific bot path to a separate plugin that can verify data or computations. As an example, an AUT 25 might accept user inputs to come up with a score. The response journal 40 could be fed into a complimentary verification program (data validator 45) that can use a verification algorithm to verify that the score that the AUT 25 comes up with is consistent. This can be used for situations as simple as verifying data integrity as the AUT 25 interacts with a user, to complex scoring and data mutation verifications.

What is claimed is:

1. A computer-implemented automaton comprising:
a plugin system;
an HTTP processor;
an application handler;
a page handler;
an input handler;
journals;
a coverage analyzer;
an expression language interpreter; and
a data validator.

2. The automaton of claim 1, wherein the HTTP processor is adapted for user-agent emulation.

3. The automaton of claim 1, wherein the journals are adapted to keep track of pages and inputs seen so far.

4. The automaton of claim 1, wherein the coverage analyzer comprises quantifying coverage of an application under test (AUT) based on at least one adequacy criteria.

5. The automaton of claim 1, wherein the expression language interpreter is adapted for controlling input processing.

6. A method of detecting states and transitions in a web based application comprising:
decomposing web pages into object representations of elements;
manipulating one of the elements;
recording outputs resulting from the step of manipulating; and
wherein a data validator is used to measure the consistency of the recorded outputs.

7. The method of claim 6, wherein the elements are HTML elements.

8. The method of claim 6, wherein the step of recording comprises using journals adapted to keep track of pages and inputs.

9. The method of claim 6, further comprising using a coverage analyzer comprising quantifying coverage of an application under test (AUT) based on at least one adequacy criteria.

10. The method of claim 6, further comprising using an expression language interpreter adapted for controlling input processing.

11. A computer-implemented automaton for testing a web based application, the automaton comprising:
a plugin system;
an HTTP processor;
an application handler comprising a domain journal, and a response journal;
a page handler configured to recognize and manipulate elements on a web page;
an input handler configured to provide inputs for use in testing the web based application;
a coverage analyzer;
an expression language interpreter is adapted for controlling input processing; and
a data validator comprising a verification algorithm for verifying outputs generated by the web based application.

12. The automaton of claim 11, wherein the web based application includes HTML elements.

13. The automaton of claim 1, wherein the coverage analyzer comprises quantifying coverage of an application under test (AUT) based on at least one adequacy criteria.
